(19) United States
(12) Patent Application Publication
(10) Pub. No.: US 2017/0345085 A1
(43) Pub. Date: Nov. 30, 2017

(54) ITEM LOCATION MANAGEMENT USING DISTRIBUTED SENSORS

(71) Applicant: International Business Machines Corporation, Armonk, NY (US)

(72) Inventors: Inseok Hwang, Austin, TX (US); Su Liu, Austin, TX (US); Eric J. Rozner, Austin, TX (US); Chin Ngai Sze, Austin, TX (US); Chungkuk Yoo, Daejeon (KR)

(21) Appl. No.: 15/168,421

(22) Filed: May 31, 2016

(51) Int. Cl. G06Q 30/06; G06Q 50/00

(52) U.S. Cl. CPC G06Q 30/0639; G06Q 50/01

(57) ABSTRACT

Disclosed aspects relate to locating a particular commercial-off-the-shelf (COTS) item using distributed sensors. A set of in-store mobile user online searches which have both a set of in-store location data and a set of COTS item identifiers may be monitored. The set of in-store mobile user online searches may be detected. In response to detecting, the set of in-store mobile user online searches may be collected in a database by a crowdsourcing engine. The set of in-store mobile user online searches may be analyzed by the crowdsourcing engine. A request to locate a particular COTS item may be received from a new user. Based on analyzing the set of in-store mobile user online searches, an in-store location for the particular COTS item may be computed. In response to receiving the request to locate the particular COTS item, the in-store location for the particular COTS item may be provided.

### BACKGROUND

This disclosure relates generally to computer systems and, more particularly, relates to locating a particular commercial-off-the-shelf item using a crowdsourcing engine. Item location may be desired to be performed as efficiently as possible. The amount of item location data that needs to be managed by enterprises is increasing. As data needing to be managed increases, the need for item location efficiency may increase.

### SUMMARY

Aspects of the disclosure relate to locating a particular commercial-off-the-shelf (COTS) item using a crowdsourcing engine. Crowdsourcing techniques may be used to collect in-store merchandise locations based on customers' mobile online product searches. Information regarding the product name or product category of a searched item may be collected and associated with the in-store location of a customer at the time of the search. Using the collected product identification information and in-store location data, a database may be established. Accordingly, an indication of a particular item's in-store location may be provided to customers who are searching for the product. Leveraging the crowd-sourced product location data may allow for fine-grained location management of merchandise in a store and facilitate shopping efficiency.

Disclosed aspects relate to locating a particular commercial-off-the-shelf (COTS) item using a crowdsourcing engine. A set of in-store mobile user online searches which have both a set of in-store location data and a set of COTS item identifiers may be monitored. The set of in-store mobile user online searches may be detected. In response to detecting, the set of in-store mobile user online searches may be collected in a database by the crowdsourcing engine. The set of in-store mobile user online searches may be analyzed by the crowdsourcing engine. A request to locate a particular COTS item may be received from a new user. Based on analyzing the set of in-store mobile user online searches, an in-store location for the particular COTS item may be computed. In response to receiving the request to locate the particular COTS item, the in-store location for the particular COTS item may be provided.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure.

FIG. 2 is a flowchart illustrating a method for locating a particular commercial-off-the-shelf (COTS) item using a crowdsourcing engine, according to embodiments.

FIG. 3 illustrates an example utilization system for locating a particular commercial-off-the-shelf (COTS) item using a crowdsourcing engine, according to embodiments.

FIG. 4 illustrates an example utilization system for locating a particular commercial-off-the-shelf (COTS) item using a crowdsourcing engine, according to embodiments.

FIG. 5 illustrates an example utilization system for locating a particular commercial-off-the-shelf (COTS) item using a crowdsourcing engine, according to embodiments.

FIG. 6 illustrates an example utilization system for locating a particular commercial-off-the-shelf (COTS) item using a crowdsourcing engine, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to locating a particular commercial-off-the-shelf (COTS) item using a crowdsourcing engine. Crowdsourcing techniques may be used to collect in-store merchandise locations based on customers' mobile online product searches. Information regarding the product name or product category of a searched item may be collected and associated with the in-store location of a customer at the time of the search (e.g., users may search online for information about a product while standing in proximity to it). Using the collected product identification information and in-store location data, a database (e.g., of product names, locations, and other statistics) may be established. Accordingly, an indication of a particular item's in-store location may be provided to customers who are searching for the product. Leveraging the crowd-sourced product location data may allow for fine-grained location management of merchandise in a store and facilitate shopping efficiency.

When shopping in a store, mall, or other commercial environment, in some situations it can be time-consuming for customers to locate the particular item or product they are searching for. For instance, in some cases the layout or arrangement of the store may be unclear, or it may be uncertain as to how a particular item has been categorized and sorted. Similarly, in some situations, stores may rearrange items based on the season, events, or sales trends, making it difficult for consumers to locate products. Accordingly, aspects of the disclosure relate to using crowd-sourcing techniques to collect in-store merchandise locations based on customers' mobile online product searches (e.g., online price checks). The in-store location of a user at the time of online query submission may be detected and associated with the particular item searched for by the user, and this information may be collected and saved in a database. As such, when a request for the location of the particular item is received from a user (e.g., a different user), the in-store location for the particular item may be provided to the user to facilitate shopping efficiency.

Aspects of the disclosure include a method, system, and computer program product for locating a particular commercial-off-the-shelf (COTS) item using a crowdsourcing engine. Aspects of the disclosure relate to monitoring for a set of in-store mobile user online searches which have both a set of in-store location data (e.g., a user's in-store location) and a set of COTS item identifiers. The monitoring may be performed with respect to a plurality of in-store users. The set of in-store mobile user online searches may include a returned result which indicates the particular COTS item. In embodiments, the set of in-store mobile user online searches may include a set of timestamps. In embodiments, monitoring may include monitoring a set of data traffic which uses an in-store wireless network. In embodiments, monitoring may include monitoring a set of user-provided queries from a set of mobile computing devices. In embodiments, monitoring may include monitoring a set of received queries by an online search engine. In response to monitoring for the set of in-store mobile user online searches, the set of in-store mobile user online searches may be detected. The detected set of in-store mobile user searches may have both the set of in-store location data of the plurality of in-store users and the set of COTS item identifiers.

Aspects of the disclosure relate to collecting the set of in-store mobile user online searches having both the set of in-store location data of the plurality of in-store users and the set of COTS item identifiers. The set of in-store mobile user online searches may be collected by the crowdsourcing engine in a database in response to detecting the set of online searches. In embodiments, collecting the set of in-store mobile user online searches may include detecting the set of in-store mobile user online searches. In embodiments, the set of in-store mobile user online searches may be captured for storage in a database in response to detection. The set of in-store mobile user online searches may be captured in association with both the set of timestamps and the set of COTS item identifiers which indicate the particular COTS item.

Aspects of the disclosure relate to analyzing the set of in-store mobile user online searches which have both the set of in-store location data of the plurality of in-store users and the set of COTS item identifiers. The analyzing may be performed by the crowdsourcing engine. In embodiments, the set of in-store location data may include a set of in-store coordinates which indicate a credible candidate location for the set of COTS item identifiers. In embodiments, the set of in-store coordinates may be based on an in-store localization infrastructure and a set of location request application program interfaces. In embodiments, the in-store location may include an aisle, an aisle-portion, and an aisle-side. Aspects of the disclosure relate to receiving a request to locate a particular COTS item, wherein the set of COTS item identifiers indicate the particular COTS item. In embodiments, the request to locate a particular COTS item may be received from a new user. In embodiments, receiving the request to locate the particular COTS item may include ingesting a shopping list which includes the particular COTS item.

Aspects of the disclosure relate to computing an in-store location for the particular COTS item. The computing may be performed by the crowdsourcing engine based on analyzing the set of in-store location data of the plurality of in-store users and the set of COTS item identifiers which indicate the particular COTS item. In embodiments, computing may include utilizing a clustering technique. In embodiments, computing may include weighting the set of in-store location data and the set of COTS item identifiers based on a set of timestamps of the set of in-store mobile user online searches. In embodiments, computing may include weighting the set of in-store location data and the set of COTS item identifiers based on a frequency factor for the set of in-store mobile data user searches.

Aspects of the disclosure relate to providing the in-store location for the particular COTS item. The in-store location for the particular COTS item may be provided to the new user in response to receiving the request to locate the particular COTS item. The in-store location may be provided using the crowdsourcing engine. In embodiments, providing the in-store location for the particular COTS item may include displaying a visual indicator of the in-store location for the particular COTS item on an electric-store map. In certain embodiments, aspects of the disclosure relate to determining a shopping route which includes the in-store location for the particular COTS item using the in-store location for the particular COTS item. In embodiments, the monitoring, detecting, collecting, analyzing, receiving, computing, providing, and other steps described herein may each occur in an automated fashion without user intervention. Altogether, aspects of the disclosure may provide performance or efficiency benefits when locating an item using crowdsourcing (e.g., speed, flexibility, responsiveness, high availability, resource usage, productivity). Aspects may save resources such as bandwidth, disk, processing, or memory.

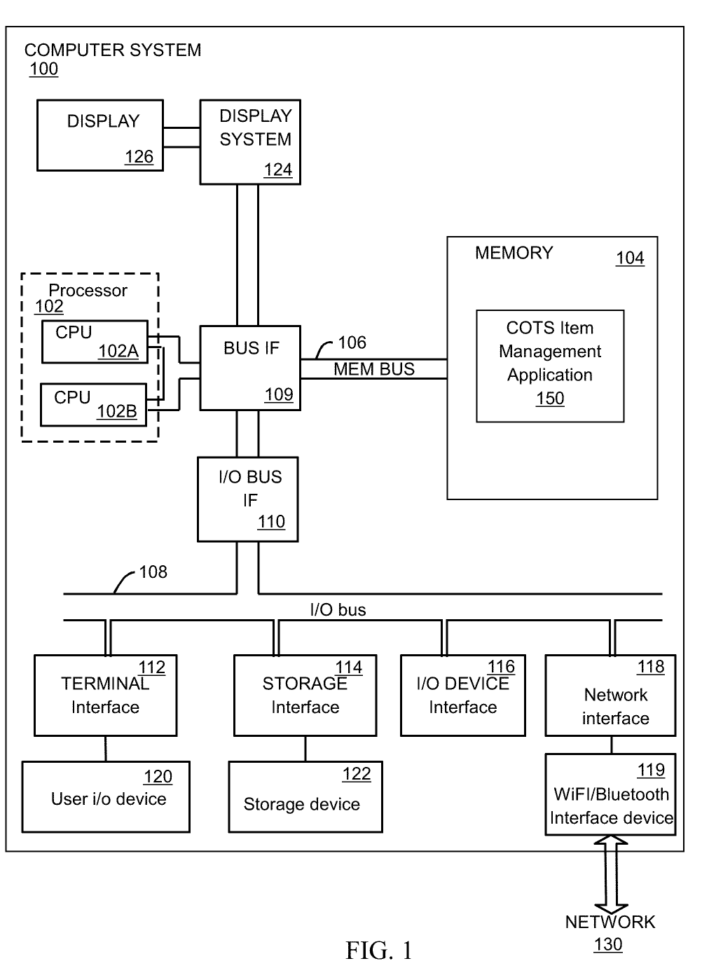

Turning now to the figures, FIG. 1 depicts a high-level block diagram of a computer system for implementing various embodiments of the present disclosure, consistent with various embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a COTS item management application 150. In embodiments, the COTS item management application 150 may include instructions or statements that execute on the processor 102 or instructions or statements that are interpreted by instructions or statements that execute on the processor 102 to carry out the functions as further described below. In certain embodiments, the COTS item management application 150 is implemented in hardware via semiconductor devices, chips, logical gates, circuits, circuit cards, and/or other physical hardware devices in lieu of, or in addition to, a processor-based system. In embodiments, the COTS item management application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130. The network interface 118 may be communicatively connected to WiFi/Bluetooth interface device 119. WiFi/Bluetooth interface device 119 may facilitate connection and network traffic management between computer system 100 and one or more wireless networks that support wireless fidelity or Bluetooth communication protocols. Various other possibilities are considered, including using microphones, WiFi fingerprinting, Bluetooth Low Energy (BLE) beacons, ultrasonic triangulation, or another indoor localization technique.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

FIG. 1 depicts several major components of the computer system 100. Individual components, however, may have greater complexity than represented in FIG. 1, components other than or in addition to those shown in FIG. 1 may be present, and the number, type, and configuration of such components may vary. Several particular examples of additional complexity or additional variations are disclosed herein; these are by way of example only and are not necessarily the only such variations. The various program components illustrated in FIG. 1 may be implemented, in various embodiments, in a number of different manners, including using various computer applications, routines, components, programs, objects, modules, data structures, etc., which may be referred to herein as “software,” “computer programs,” or simply “programs.”

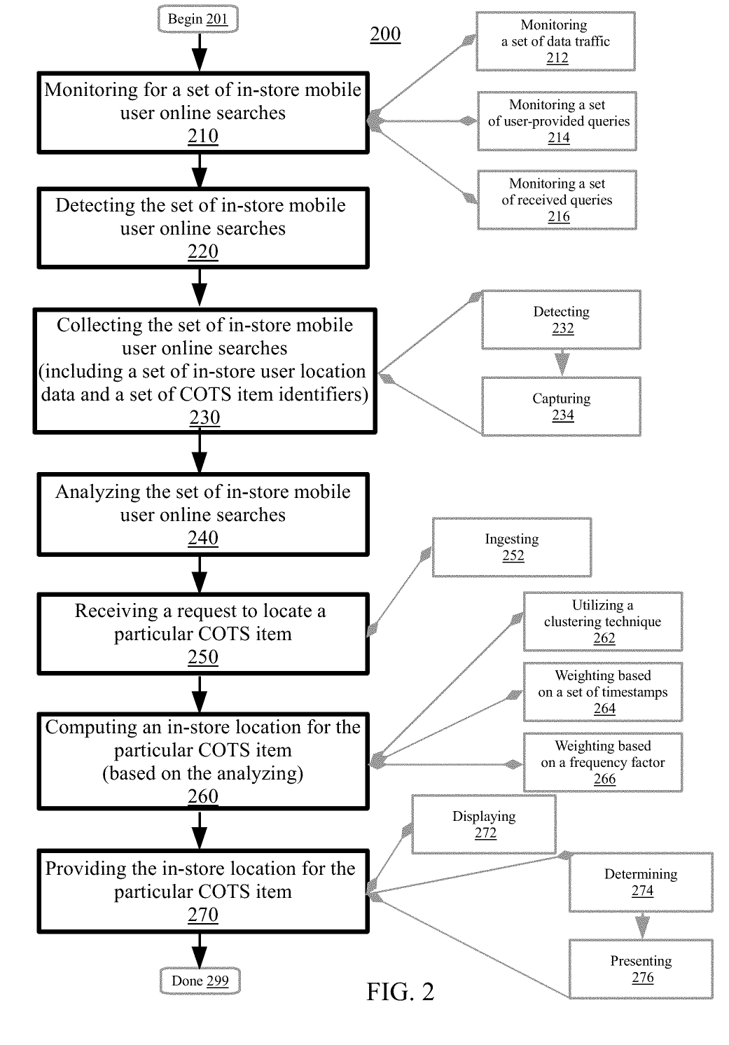

FIG. 2 is a flowchart illustrating a method 200 for locating a particular commercial-off-the-shelf (COTS) item using a crowdsourcing engine. Aspects of method 200 relate to using crowdsourcing techniques to collect a set of in-store mobile user online searches, and determining an in-store location for a particular COTS item based on the set of in-store mobile user online searches. The in-store location for the particular COTS item may be provided to a new user in response to receiving a request to locate the particular COTS item. Generally, the COTS item can include products, items, commodities, or services offered for sale in a commercial marketplace. Examples of COTS items can include grocery items, furniture items, appliances, electronics, home supplies, and the like. In embodiments, both product categories (e.g., tomato sauce) and individual product names (e.g., ACME Store's amazing organic tomato sauce with garlic) are supported. Leveraging the set of in-store mobile user online searches and the set of in-store location data may facilitate location of in-store merchandise. The method 200 may begin at block 201.

At block 210, a set of in-store mobile user online searches may be monitored. The set of in-store mobile user online searches may have both a set of in-store location data and a set of commercial-off-the-shelf (COTS) item identifiers. The monitoring may be performed with respect to a plurality of in-store users. Generally, monitoring can include observing, inspecting, surveying, checking, or scanning for the set of in-store mobile user online searches. In embodiments, monitoring can include using a software application, computing node, network traffic monitor, search engine data gathering tool, or other technique to aggregate information related to search queries submitted by the plurality of in-store users (e.g., to a search engine). For instance, in embodiments, a software application installed on the mobile device of an in-store user may be configured to monitor the user's search engine submissions to identify the set of in-store mobile user online searches. Other methods of monitoring for the set of in-store mobile user online searches are also possible.

In embodiments, the set of in-store mobile user online searches can include questions, inquiries, or other queries submitted to internet-based search engines or other online services by users. In embodiments, aspects of the disclosure relate to monitoring the online searches of in-store users. The in-store users may include individuals (e.g., customers) who submit search queries while located in stores, malls, shopping centers, or other retail environments. As described herein, the set of in-store mobile user online searches may include both a set of in-store location data and a set of COTS item identifiers. The set of in-store location data may include information regarding the place of activity or position of one or more users within a store or other shopping environment. The set of in-store location data may represent the absolute position (e.g., expressed in geographic coordinates) or the relative position (e.g., aisle 13 near the frozen food section) of the user. In embodiments, the set of COTS item identifiers can include tags, markers, or other indicators that specify or designate a particular product, item, merchandise, or service (e.g., Hartman's Freshly Squeezed 100% Lychee Juice). In embodiments, the set of COTS item identifiers may designate a broad category of items or services (e.g., nuts). As examples, the set of COTS item identifiers may include product names, serial numbers, product descriptors, manufacturer/distributor information, or the like. As an example, in certain embodiments, an in-store user may submit an online search for “spaghetti noodles.” In embodiments, the set of in-store mobile user online searches may include a returned result which indicates the particular COTS item. For example, for an online search of “Honeygrove All-Natural Pineapple Juice,” search results including images, product information, purchase links, and other information regarding “Honeygrove All-Natural Pineapple Juice” may be returned. Other types of in-store mobile user online searches are also possible.

In embodiments, monitoring for the set of in-store mobile user online searches may include monitoring a set of data traffic at block 212. The set of data traffic may use an in-store wireless network (e.g., Wi-fi, Bluetooth). Aspects of the disclosure, in embodiments, relate to analyzing the network traffic of mobile computing devices connected to an in-store wireless network (e.g., local Wi-fi network provided within a store or mall) to identify the set of in-store mobile user online searches. For example, a network traffic analysis node or other middleware application stationed in the in-store network may be configured to inspect the network traffic of mobile computing devices connected to the in-store wireless network and extract the set of in-store mobile user online searches (e.g., those search queries that have both the set of in-store location data and the set of COTS item identifiers). In embodiments, the network traffic analysis node may filter out search queries that are not related to products or services offered by the store providing the in-store wireless network. Other methods of monitoring the set of data traffic are also possible.

In embodiments, monitoring for the set of in-store mobile user online searches may include monitoring a set of user-provided queries at block 214. The set of user-provided queries may be received from a set of mobile computing devices. In embodiments, monitoring the set of user-provided queries may include using an application installed on a mobile computing device (e.g., smartphone, tablet, laptop computer) of an in-store user to capture the set of in-store mobile user online searches. In embodiments, the user-provided queries may be submitted via the mobile application. In embodiments, the user-provided queries may be submitted using an internet browser application or other software program, and information regarding the user-provided queries may be collected and recorded. As an example, an in-store user may initialize an internet browser application on their mobile device, and submit a search query for “bicycles.” Accordingly, the search query of the user may be collected by a mobile application and recorded. As described herein, in-store location data for the in-store user who submitted the search query may also be recorded. Other methods of monitoring the set of user-provided queries are also possible.

In embodiments, monitoring for the set of in-store mobile user online searches may include monitoring a set of received queries by an online search engine at block 216. In embodiments, aspects of the disclosure relate to gathering information regarding the search queries of in-store users from the online search engine to which the search queries were submitted. For instance, in certain embodiments, a retail store may collaborate with an internet-based search engine provider (e.g., subscribe to a service offered by the search engine provider) and receive updates from the search engine provider regarding which products were searched by in-store users (e.g., information regarding the time of the search submission and the in-store location of the user may also be provided). In embodiments, the internet-based search engine may include a script that detects search queries submitted by in-store users, and information regarding the detected search queries may be relayed to a retail store. Other methods of monitoring the set of queries received by the online search engine are also possible.

The set of in-store mobile user online searches may be detected at block 220. The set of in-store mobile user online searches may be detected in response to monitoring. As described herein, the set of in-store mobile user online searches may include both the set of in-store location data of the plurality of in-store users and the set of COTS item identifiers. Generally, detecting can include recognizing, discovering, ascertaining, sensing, determining, or otherwise identifying the set of in-store mobile user online searches. As described herein, in embodiments, the detecting may be performed by a mobile application installed on a mobile computing device of the in-store user, the search engine provider, or by a network traffic analysis node stationed within the local network of the shopping environment. In embodiments, detecting can include inspecting a set of network traffic to identify the set of in-store mobile user online searches that include both the set of in-store location data for the plurality of in-store users and the set of COTS item identifiers. For instance, detecting may include examining a set of network traffic from the mobile-devices of in-store users, and filtering out search requests that are not related to online product searches (e.g., search queries that do not contain COTS item identifiers). Search requests that do not include the set of in-store location data (e.g., a search request from a user who chose to opt out of location data collection) may also be filtered out from the network traffic. Accordingly, the set of in-store mobile user online searches that include both the set of in-store location data of the plurality of in-store users and the set of COTS item identifiers may be detected. Other methods of detecting the set of in-store mobile user online searches are also possible.

Consider the following example. A network traffic analysis node stationed within a wireless network at a grocery store may receive a set of network traffic including 10 search queries. The network traffic analysis node may inspect the received set of network traffic and determine that, of the 10 search queries, 4 were submitted by users outside of the grocery store (e.g., users accessing the wireless network from outside the store or from other nearby buildings). Accordingly, these search queries may be filtered out from the set of network traffic. Of the remaining 6 search queries, the network traffic analysis node may determine that 2 of them were not related to products or services offered by the grocery store (e.g., furniture and stock market investments). In embodiments, the remaining 4 search queries may be detected as including both the set of in-store location data of the plurality of in-store users and the set of COTS item identifiers. For example, a first search query regarding “wheat crackers” may be received from a user in aisle 2, a second search query regarding “organic honey” may be received from a user in isle 4, a third search query regarding “carrots” may be received from a user in isle 11, and a fourth search query regarding “Johnson's Home-Made Turnip 'n Tater Pie” may be received from a user in isle 9. Accordingly, these four search queries may be detected as the set of in-store mobile user online searches including both the set of in-store location data of the plurality of in-store users and the set of COTS item identifiers. Other methods of detecting the set of in-store mobile user online searches are also possible.

At block 230, the set of in-store mobile user online searches may be collected in a database by the crowdsourcing engine. The set of in-store mobile user online searches may be collected in response to detecting the set of in-store mobile user online searches. As described herein, the set of in-store mobile user online searches may include both the set of in-store location data of the plurality of in-store users and the set of COTS item identifiers. Generally, collecting can include gathering, obtaining, recording, receiving, or otherwise aggregating the set of in-store mobile user online searches. In embodiments, collecting can include determining one or more search queries that include both the set of in-store location data of the plurality of in-store users and the set of COTS item identifiers (e.g., detected at block 220), and establishing the information in an organized data structure (e.g., database, directory, index). For instance, different data entries may be created for each attribute (e.g., in-store location of the user, COTS item identifier) of a particular search query. In embodiments, collecting can include identifying a set of timestamps for the set of in-store mobile user online searches. The set of timestamps may indicate the time at which the online search was submitted to a search engine or other system for processing. Other methods of collecting the set of in-store mobile user online searches are also possible.

In embodiments, collecting the set of in-store mobile user online searches may include detecting the set of in-store mobile user online searches at block 232. Generally, detecting can include recognizing, discovering, ascertaining, sensing, determining, or otherwise identifying the set of in-store mobile user online searches. As described herein, in certain embodiments, detecting the set of in-store mobile user online searches can include inspecting a set of network traffic to identify the set of in-store mobile user online searches that include both the set of in-store location data for the plurality of in-store users and the set of COTS item identifiers. In embodiments, in response to detecting the set of in-store mobile user online searches, the set of in-store location data may be captured for storage in a database at block 234. Generally, capturing can include collecting, storing, logging, or recording the set of in-store location data in a database in association with both the set of timestamps and the set of COTS item identifiers for a particular COTS item. In embodiments, capturing can include identifying the set of in-store location data, COTS item identifier, and timestamp for a particular search query and storing it in an online search database maintained by the crowdsourcing engine. As an example, a new data entry may be created in the online search database that records the contents of a particular search query (e.g., question/phrase searched by the in-store user), the COTS item identifiers included in the query (e.g., whole-grain bread), the location of the in-store user at the time of query submission (e.g., aisle 1), and the time indicated by the timestamp associated with the query (e.g., 4:51 PM). Other methods of detecting the set of in-store mobile user online searches and capturing the set of in-store location data in association with both the set of timestamps and the set of COTS item identifiers are also possible.

At block 240, the set of in-store mobile user online searches may be analyzed by the crowdsourcing engine. The set of in-store mobile user online searches may include both the set of in-store location data of the plurality of in-store users and the set of COTS item identifiers. Generally, analyzing can include examining (e.g., performing an inspection of the set of in-store mobile user online searches), evaluating (e.g., generating an appraisal of the set of in-store mobile user online searches), resolving (e.g., ascertaining an observation/conclusion/answer with respect to the set of in-store mobile user online searches), parsing (e.g., deciphering structured and unstructured data constructs of the set of in-store mobile user online searches), querying (e.g., asking a question regarding the set of in-store mobile user online searches), or categorizing (e.g., organizing by a feature or type of the set of in-store mobile user online searches). Data analysis may include a process of inspecting, cleaning, transforming, or modeling data to discover useful information, suggest conclusions, or support decisions. Data analysis can extract information/patterns from a data set and transform/translate it into an understandable structure for further use. As an example, analyzing the set of in-store mobile user online searches can include using one or more natural language processing techniques to examine syntactic and semantic elements including word frequency, word meanings, text font, italics, hyperlinks, proper names, noun phrases, parts-of-speech, and the context of words to identify attributes or characteristics regarding the nature of the set of in-store mobile user online searches (e.g., set of COTS identifiers, product information).

In certain embodiments, analyzing the set of in-store mobile user online searches may include resolving a set of in-store coordinates which indicate a credible candidate location for the set of COTS item identifiers. Resolving the set of in-store coordinates may include evaluating the in-store location data of the plurality of in-store users to ascertain a likely location for the COTS item. For instance, the in-store location data may be revised to account for errors in location detection (e.g., triangulation technique inaccuracy), and correlated with similar products/product categories that are located nearby the particular COTS item. Other methods of analyzing the set of in-store mobile user online searches are also possible.

At block 250, a request to locate a particular COTS item may be received. The request to locate the particular COTS item may be received from a new user. In embodiments, the new user may include a customer or individual searching for a particular COTS item within a store or shopping environment. In embodiments, the new user may be a different individual than the user from whom the in-store mobile user online search (e.g., for the particular COTS item) was collected. Generally, receiving can include obtaining, collecting, acquiring, or otherwise accepting delivery of the request to locate the particular COTS item. The request to locate the particular COTS item may include an indication or expression of a desire (e.g., of the new user) to ascertain the location of the particular COTS item. In embodiments, the request to locate the particular COTS item may be received from a mobile device of the new user. The request to locate the particular COTS item may be received by a crowdsourcing engine stationed locally (e.g., within an in-store local network) or remotely (e.g., cloud computing node). In embodiments, the new user may utilize a mobile application installed on his/her mobile device to indicate a particular COTS item that he or she wishes to find within the store. The mobile application may display a visual representation of the item inventory for the store, and a user may select one or more COTS items that he or she wishes to locate (e.g., to purchase). As an example, a new user may enter a store, and initialize a COTS item locator mobile application on his/her mobile device. Using the mobile application, the user may indicate a request to locate “brown sugar.” The request to locate “brown sugar” may be received by the crowdsourcing engine. In embodiments, the request to locate the particular COTS item may be received using a public COTS item locator terminal stationed within the store or shopping environment. Other methods of receiving the request to locate the particular COTS item are also possible.

In embodiments, receiving the request to locate the particular COTS item may include ingesting a shopping list which includes the particular item at block 252. Generally, ingesting can include importing, bringing in, accepting submission, normalizing, transforming, or otherwise acquiring the shopping list. The shopping list may include a series of one or more items (e.g., COTS items) that a user intends to purchase. In embodiments, ingesting the shopping list can include receiving a user's input of the shopping list. For instance, a user may make use of an application on his or her mobile device to manually input one or more items and compose a shopping list. In embodiments, ingesting the shopping list may include importing a picture of a hand-written shopping list, and using one or more optical character recognition techniques to identify the items recorded in the shopping list. Once identified, the items may be associated with corresponding products from an online catalogue or product database, and information such as price, inventory amount, popularity, in-store location, and other information may be added to the shopping list. Other methods of ingesting the shopping list are also possible.

At block 260, an in-store location for the particular COTS item may be computed. The in-store location for the particular COTS item may be computed by the crowdsourcing engine based on analyzing the set of in-store location data of the plurality of in-store users and the set of COTS item identifiers. Generally, computing can include calculating, identifying, ascertaining, or otherwise determining the in-store location for the particular COTS item. In embodiments, computing the in-store location for the particular COTS item may include determining a set of credible candidate locations for the set of COTS item identifiers. The set of credible candidate locations may be in-store locations associated with one or more COTS item identifiers. The credible candidate locations may be associated with a likelihood (e.g., probability above a threshold) that the particular COTS item can be found there. Aspects of the disclosure relate to the recognition that, in embodiments, some shopping items may be located at multiple locations within a store or shopping area, and similarly that some locations may be associated with COTS item identifiers despite the item not being located there (e.g., advertisements for products in another part of the store, certain items placed in special locations based on season, sales trends, or the like). Accordingly, in embodiments, computing the in-store location for the particular COTS item may include weighting a variety of factors including the set of in-store user location data, number of search queries associated with each store location, type of item identifiers (e.g., product name, product type, price), and other information to determine the in-store location (e.g., list of credible candidate locations) of the particular COTS item. Other methods of computing the in-store location of the particular COTS item are also possible.

In embodiments, the set of credible candidate locations may be associated with a set of in-store coordinates. The set of in-store coordinates may be expressed in absolute geographical coordinates (e.g., latitude and longitude) or as a relative location (e.g., near the home improvement department). In embodiments, the in-store location may be expressed as an aisle (e.g., aisle 11), aisle portion (e.g., north half of aisle 9, middle of aisle 12), and an aisle-side (e.g., left half of aisle 2, right half of aisle 7). In embodiments, the set of in-store coordinates may be based on an in-store localization structure. The in-store localization structure may include an in-store grid based coordinate system, such that the store is divided up into blocks to facilitate identification (e.g., block C4, block H6). In certain embodiments, the set of in-store coordinates may be based on a set of location request application program interfaces. The set of location request application program interfaces may include mobile or web-based interfaces (e.g., managed by the crowdsourcing engine) that utilize the in-store locations of the plurality of in-store users as a basis to provide real-time COTS item location information (e.g., an online search query for “cream cheese” was recently received from aisle 14, and so other in-store users searching for cream cheese may be notified of the location). Other types of in-store coordinates are also possible.

In embodiments, computing the in-store location for the particular COTS item may include utilizing a clustering technique at block 262. Generally, utilizing the clustering technique may include making use of one or more methods of statistical data analysis for grouping one or more objects (e.g., the set of in-store mobile user online searches), and identifying patterns, links, and relationships between members of the group. As examples, the clustering technique can include k-means clustering, hierarchical clustering models, multivariate normal distributions, connectivity models, centroid models, density models, group models, graph-based models, or the like. For instance, in embodiments, utilizing the clustering technique may include analyzing the density distribution of the in-store location of a plurality of users who submitted search requests for a particular COTS item. As an example, in certain embodiments, the density distribution may indicate that 77% of search requests for “laundry detergent” were submitted by users with an in-store location of aisle 10, 13% of the search requests were submitted from the store entrance, 4% were submitted from aisle 4, 3% were submitted from aisle 2, and 3% were submitted from aisle 13. Accordingly, in embodiments, aisle 10 may be identified as the in-store location for “laundry detergent.” Other methods of utilizing the clustering technique are also possible.

In embodiments, computing the in-store location for the particular COTS item may include weighting the set of in-store location data and the set of COTS item identifiers based on a set of timestamps of the set of in-store mobile user online searches at block 264. Generally, weighting can include assigning a greater or lesser amount of importance, emphasis, or impact to certain in-store locations or item identifiers based on the set of timestamps for the set of in-store mobile user online searches. In embodiments, aspects of the disclosure relate to assigning a heavier weight (e.g., greater relative importance) to in-store locations and item identifiers that are associated with search queries that have more recent timestamps (e.g., more recent search queries may represent more up-to-date location information and product data than older search queries). Consider the following example. 30 search queries pertaining to “J. T. Thornman's Original Formula Bonsai Fertilizer” may be received from in-store users over a two-week time period. 18 of the search queries may have a timestamp between November 9th and November 13th, and be submitted by users in aisle 6. The remaining 12 search queries may have a timestamp between November 16th and November 20th, and be submitted by users in aisle 12. Accordingly, in embodiments, more weight may be assigned to the more recent search queries, and aisle 12 may be determined as the in-store location for “J. T. Thornman's Original Formula Bonsai Fertilizer.” Other methods of weighting the set of in-store location data and the set of COTS item identifiers based on a set of timestamps are also possible.

In embodiments, computing the in-store location for the particular COTS item may include weighting the set of in-store location data and the set of COTS item identifiers based on a frequency factor for the set of in-store mobile user online searches at block 266. As described herein, weighting can include assigning a greater or lesser amount of importance, emphasis, or impact to certain in-store locations or item identifiers based on the frequency (e.g., number of searches per given time period) of online searches received from users at a particular in-store location. In embodiments, aspects of the disclosure relate to assigning a heavier weight (e.g., greater relative importance) to in-store locations and item identifiers that are associated with search queries that have a higher search frequency. For instance, in embodiments, for a COTS item that has been searched for 9 times in a single day period from aisle 3, and 14 times over a week period from aisle 8, more weight may be assigned to those search queries received from aisle 3 (e.g., higher search frequency may indicate greater likelihood of the item being present at the location). Other methods of weighting the set of in-store location data and the set of COTS item identifiers based on a frequency factor are also possible.

At block 270, the in-store location for the particular COTS item may be provided. The in-store location for the particular COTS item may be provided by the crowdsourcing engine to the new user in response to receiving the request to locate the particular COTS item. Generally, providing can include presenting, displaying, supplying, demonstrating, or otherwise conveying notification of the in-store location of the particular COTS item. In embodiments, providing the in-store location for the particular COTS item may include transmitting a notification (e.g., mobile app notification, text message, email message) to the mobile device of the new user to inform them of the in-store location of the particular COTS item. For instance, the new user may receive a text message indicating the relative or absolute location in the store where the particular COTS item can be found. As an example, in response to receiving a request from a first user regarding “tofu,” a text message may be delivered to the mobile device of the first user informing them that “tofu” is located in aisle 16, between “soy milk” and “plain yogurt.” Other methods of providing the in-store location for the particular COTS item are also possible.

In embodiments, providing the in-store location may include displaying a visual indicator of the in-store location of the particular COTS item on an electronic store-map at block 272. Generally, displaying can include illustrating, demonstrating, exhibiting, or otherwise presenting the visual indicator of the in-store location of the particular COTS item. In embodiments, displaying can include transmitting an electronic store-map to the mobile device of an in-store user, with the in-store location of the particular COTS item marked on the electronic store-map by the visual indicator. The visual indicator can include a mark, symbol, tag, or other identifier that represents the in-store location of the particular COTS item. For instance, in certain embodiments, the visual indicator may include a red star placed on the electronic store-map that corresponds to the in-store location of the particular COTS item. As another example, the visual indicator may include a picture (e.g., realistic or stylized) of the particular COTS item (e.g., a picture of a carrot). In embodiments, displaying the in-store location may include updating a public electronic map terminal stationed within the store or shopping area. Other methods of displaying a visual indicator of the in-store location of the particular COTS item on an electronic store-map are also possible.

In embodiments, a shopping route which includes the in-store location for the particular COTS item may be determined at block 274. The shopping route may be determined using the in-store location for the particular COTS item. Generally, determining can include identifying, ascertaining, creating, or otherwise establishing the shopping route. In embodiments, determining the shopping route may include generating a suggested path for a user to take in order to acquire the particular COTS item. In certain embodiments, a set of candidate paths may be generated that each offer different benefits. For instance, a first path may offer the most direct path to the particular COTS item, but take the user through high-traffic areas of the store (e.g., collection of the particular COTS item may be slowed by other shoppers), while a second path avoids high-traffic areas but requires that the user walk a farther distance. In embodiments, determining the shopping route may include importing a shopping list for a user, and generating a shopping route to facilitate efficient procurement of each item on the shopping list (e.g., using the in-store location for each item to minimize user travel). Other methods of determining the shopping route are also possible.

In embodiments, the shopping route may be presented at block 276. Generally, presenting can include illustrating, demonstrating, exhibiting, displaying, or otherwise providing the shopping route. In embodiments, presenting may include transmitting the shopping route to the mobile device of a user. For instance, the shopping route may be provided to the user as a series of textual directions (e.g., enter the store, turn left at the first intersection, turn right into aisle 5) in an email message. In embodiments, presenting the shopping route may include generating a visual render of the store layout to assist the user in navigating to the in-store location of the particular COTS item. In certain embodiments, presenting the shopping route may include programming an in-store transportation device (e.g., cart, scooter) to transport the user from a starting location to the in-store location of one or more COTS items and then back to the starting location (e.g., for checkout). Other methods of presenting the shopping route are also possible.

In certain embodiments, the monitoring, the detecting, the collecting, the analyzing, the receiving, the computing, the providing, and other steps described herein may each occur in an automated fashion without user intervention. In embodiments, the monitoring, the detecting, the collecting, the analyzing, the receiving, the computing, the providing, and other steps described herein may be carried out by an internal COTS item location management module maintained in a persistent storage device of a computing node that is located in a local network (e.g., in-store wireless network). In certain embodiments, the steps described herein may be carried out by a COTS item location management module hosted by a remote computing device (e.g., accessible via a subscription, usage-based, or other service model).

Method 200 concludes at block 299. Aspects of method 200 may provide performance or efficiency benefits for COTS item location management. For example, aspects of method 200 may have positive impacts with respect to item procurement efficiency and inventory management. As described herein, the monitoring, detecting, collecting, analyzing, receiving, computing, and providing described herein may each occur in an automated fashion without user intervention. Altogether, leveraging a set of in-store mobile user online searches to provide information regarding the in-store location of a particular COTS item may be associated with positive benefits (e.g., speed, flexibility, responsiveness, productivity).

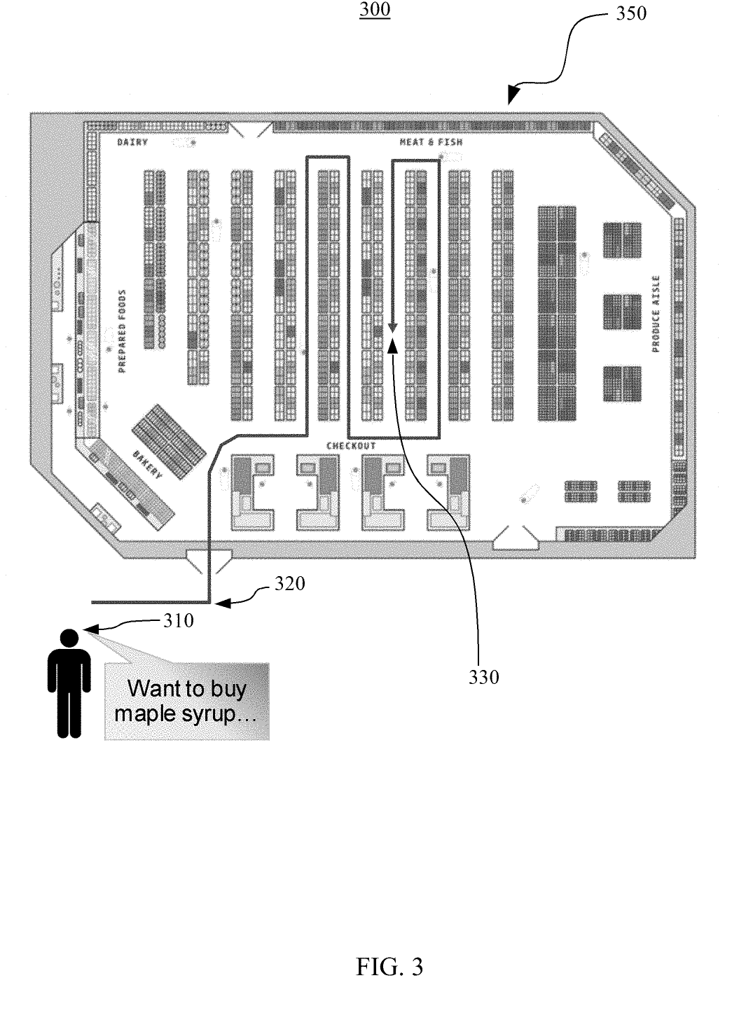

FIG. 3 illustrates an example utilization system 300 for locating a particular commercial-off-the-shelf (COTS) item using a crowdsourcing engine. Aspects of example utilization system 300 relate to a situation in which a first user searches for a particular COTS item in a shopping environment. Consider the following example. In embodiments, a user 310 may enter a grocery store 350. The user 310 may wish to locate a particular COTS item in the grocery store 350. For example, in certain embodiments, the user 310 may wish to locate a particular COTS item of “maple syrup.” Accordingly, the user 310 may navigate the grocery store 350 according to the route indicated by shopping path 320 in search of maple syrup. In embodiments, the user 310 may locate the maple syrup at in-store location 330.

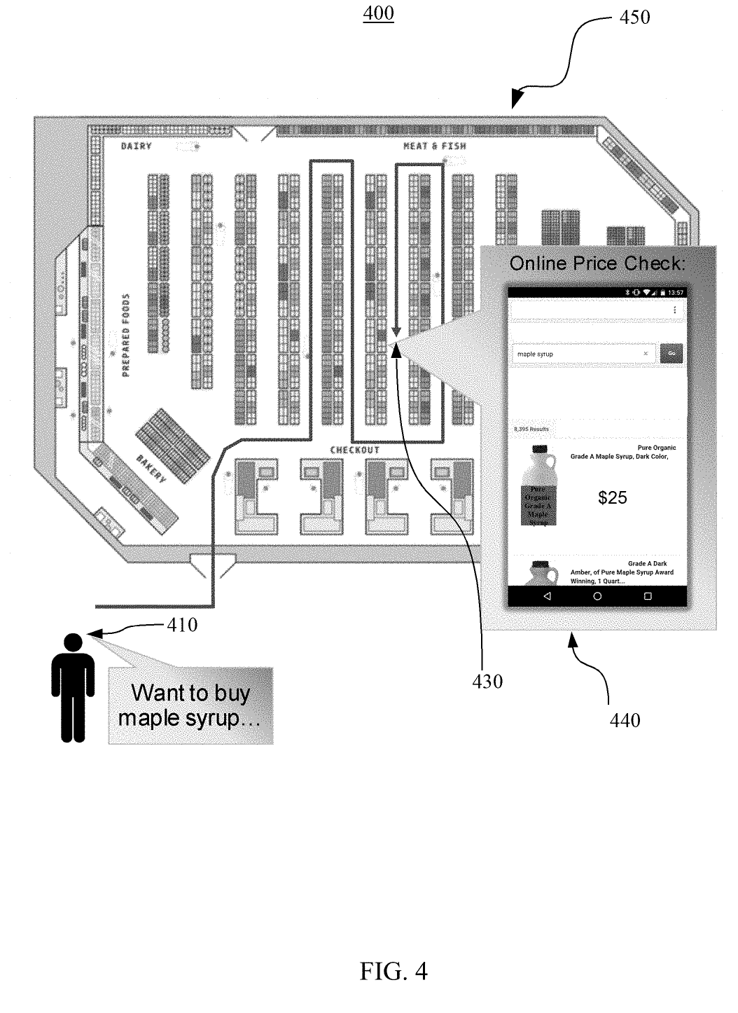

FIG. 4 illustrates an example utilization system 400 for locating a particular commercial-off-the-shelf (COTS) item using a crowdsourcing engine. Aspects of FIG. 4 may substantially correspond to other embodiments described herein. Aspects of example utilization system 400 relate to monitoring for and detecting a set of in-store mobile user online searches. The set of in-store mobile user online searches may facilitate computation (e.g., determination) of the in-store location for a particular COTS item. Consider the following example. In embodiments, a user 410 may locate a particular COTS item (e.g., maple syrup) at in-store location 430 in grocery store 450. Once the user 410 has located the particular COTS item he or she was searching for, he or she may submit a search query to an online search engine (e.g., to compare the price of the item) using a personal mobile device (e.g., smartphone). For example, online search query 440 may be submitted to an online search engine by user 410. Aspects of the disclosure relate to monitoring for in-store mobile user online searches. Accordingly, online search query 440 may be detected. In embodiments, online search query 440 may be detected by a mobile application installed on the mobile computing device of user 410, the search engine provider to which the search claim was submitted, or by a network traffic analysis node stationed within the local network of the grocery store 450. Other methods of monitoring and detecting in-store mobile user online searches are also possible.

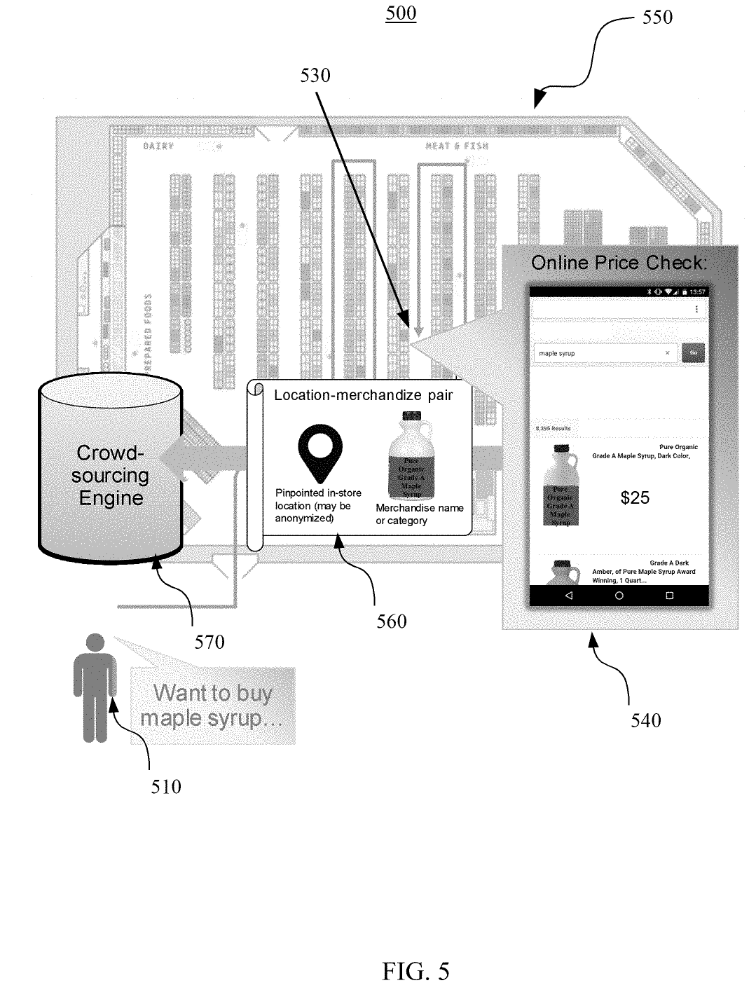

FIG. 5 illustrates an example utilization system 500 for locating a particular commercial-off-the-shelf (COTS) item using a crowdsourcing engine. Aspects of FIG. 5 may substantially correspond to other embodiments described herein. Aspects of example utilization system 500 relate to collecting and analyzing a set of in-store mobile user online searches. The set of in-store mobile user online searches may facilitate computation (e.g., determination) of the in-store location for a particular COTS item. Consider the following example. In response to receiving an online search query 540 (e.g., for performing a price check on maple syrup) from a user 510, both a set of in-store location data for the user 510 as well as a set of COTS item identifiers may be collected. For instance, the set of in-store location data may indicate that the user is located at in-store location 530 (e.g., aisle 7) of grocery store 550, and the set of COTS item identifiers may include a product category of “maple syrup.” Accordingly, the in-store location data for the user 510 and the set of COTS item identifiers may be associated with one another as location-merchandise pair 560. As described herein, location merchandise pair 560 may be collected and stored in a database managed by crowdsourcing engine 570. In embodiments, the crowdsourcing engine 570 may be configured to analyze the location merchandise pair 560 (e.g., to facilitate computation of an in-store location for a particular COTS item). Other methods of collecting and analyzing the in-store mobile user online searches are also possible.

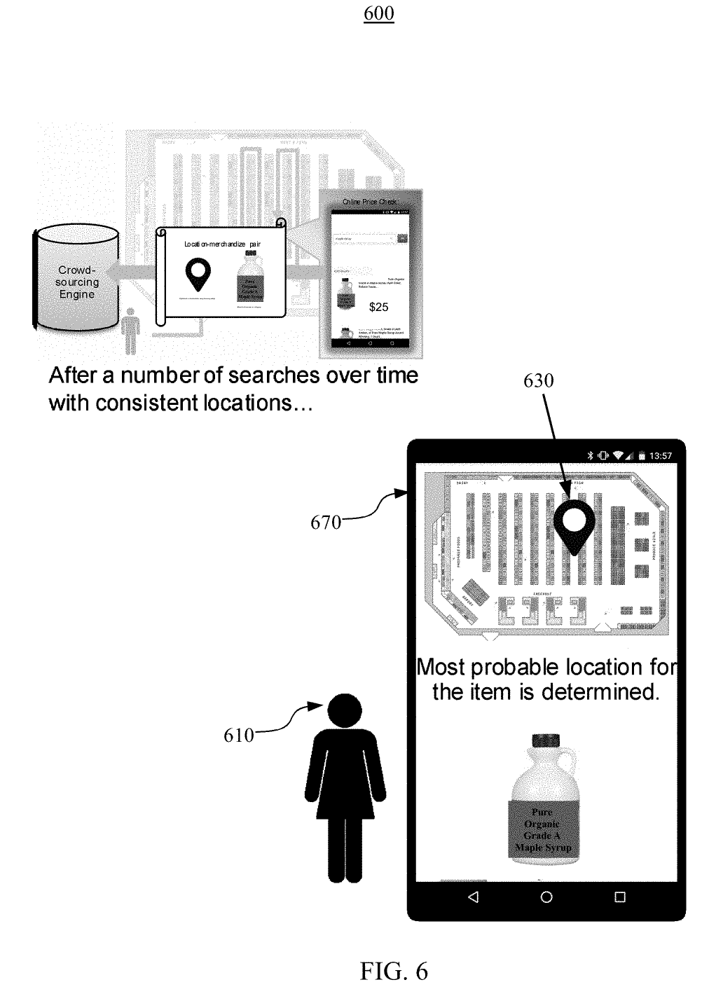

FIG. 6 illustrates an example utilization system 600 for locating a particular commercial-off-the-shelf (COTS) item using a crowdsourcing engine. Aspects of FIG. 6 may substantially correspond to other embodiments described herein. Aspects of example utilization system 600 relate to receiving a request to locate a particular COTS item, computing an in-store location for the particular COTS item, and providing the in-store location for the particular COTS item to a user. Leveraging a set of in-store mobile user online searches may facilitate in-store merchandise location efficiency. Consider the following example. Using crowdsourcing techniques, a plurality of in-store mobile user online searches may be monitored, detected, collected, and analyzed by a crowdsourcing engine such that a database of location-merchandise pairs may be constructed for the inventory of a store or shopping area. In embodiments, aspects of the disclosure relate to receiving a location request for a particular COTS item from a user 610. In embodiments, the location request may be for a particular COTS item of “maple syrup.” Accordingly, the crowdsourcing engine may compute an in-store location for maple syrup based on the archived location-merchandise pairs collected in the database. For instance, in embodiments, the crowdsourcing engine may compute that maple syrup is located in-store location 630 (e.g., aisle 7) of the grocery store. In embodiments, as described herein, a notification 670 of the in-store location of the particular COTS item may be provided to user 610. Other methods of receiving a request to locate a particular COTS item, computing an in-store location for the particular COTS item, and providing the in-store location for the particular COTS item to a user are also possible.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for locating a particular commercial-off-the-shelf (COTS) item using a crowdsourcing engine, the method comprising:
monitoring, with respect to a plurality of in-store users, for a set of in-store mobile user online searches which have both a set of in-store location data of the plurality of in-store users and a set of COTS item identifiers;
collecting, by the crowdsourcing engine in a database in response to detecting the set of in-store mobile user online searches, the set of in-store mobile user online searches which have both the set of in-store location data of the plurality of in-store users and the set of COTS item identifiers;
analyzing, by the crowdsourcing engine, the set of in-store mobile user online searches which have both the set of in-store location data of the plurality of in-store users and the set of COTS item identifiers;
receiving, from a new user, a request to locate a particular COTS item, wherein the set of COTS item identifiers indicates the particular COTS item;
computing, by the crowdsourcing engine based on the analyzing of the set of in-store location data of the plurality of in-store users and the set of COTS item identifiers which indicates the particular COTS item, an in-store location for the particular COTS item; and
providing, by the crowdsourcing engine to the new user in response to receiving the request to locate the particular COTS item, the in-store location for the particular COTS item.

2. The method of claim 1, wherein monitoring for the set of in-store mobile user online searches which have both the set of in-store location data and the set of COTS item identifiers includes:
monitoring a set of data traffic which use an in-store wireless network.

3. The method of claim 1, wherein monitoring for the set of in-store mobile user online searches which have both the set of in-store location data and the set of COTS item identifiers includes:
monitoring a set of user-provided queries from a set of mobile computing devices.

4. The method of claim 1, wherein monitoring for the set of in-store mobile user online searches which have both the set of in-store location data and the set of COTS item identifiers includes:
monitoring a set of received queries by an online search engine.

5. The method of claim 1, wherein the set of in-store mobile user online searches include a returned result which indicates the particular COTS item.

6. The method of claim 1, wherein the set of in-store mobile user online searches have a set of timestamps.

7. The method of claim 6, wherein collecting the set of in-store mobile user online searches includes:
detecting the set of in-store mobile user online searches; and
capturing, for storage in a database in response to detecting the set of in-store mobile user online searches, the set of in-store location data in association with both the set of timestamps and the set of COTS item identifiers which indicates the particular COTS item.

8. The method of claim 1, wherein analyzing the set of in-store mobile user online searches includes:
resolving a set of in-store coordinates which indicates a credible candidate location for the set of COTS item identifiers.

9. The method of claim 8, wherein the set of in-store coordinates is based on:
an in-store localization infrastructure, and
a set of location request application program interfaces.

10. The method of claim 1, wherein the in-store location includes an aisle, an aisle-portion, and an aisle-side.

11. The method of claim 1, wherein computing, based on the set of in-store location data and the set of COTS item identifiers which indicates the particular COTS item, the in-store location for the particular COTS item includes:
utilizing a clustering technique.

12. The method of claim 1, wherein computing, based on the set of in-store location data and the set of COTS item identifiers which indicates the particular COTS item, the in-store location for the particular COTS item includes:
weighting, based on a set of timestamps of the set of in-store mobile user online searches, the set of in-store location data and the set of COTS item identifiers which indicates the particular COTS item.

13. The method of claim 1, wherein computing, based on the set of in-store location data and the set of COTS item identifiers which indicates the particular COTS item, the in-store location for the particular COTS item includes:
weighting, based on a frequency factor for the set of in-store mobile user online searches, the set of in-store location data and the set of COTS item identifiers which indicates the particular COTS item.

14. The method of claim 1, wherein receiving the request to locate the particular COTS item includes:
ingesting a shopping list which includes the particular COTS item.

15. The method of claim 1, wherein providing the in-store location for the particular COTS item includes:
displaying, on an electronic store-map, a visual indicator of the in-store location for the particular COTS item.

16. The method of claim 1, further comprising:
determining, using the in-store location for the particular COTS item, a shopping route which includes the in-store location for the particular COTS item; and
presenting the shopping route.

17. The method of claim 1, wherein the monitoring, the detecting, the collecting, the analyzing, the receiving, the computing, and the providing each occur in an automated fashion without user intervention.

18. A system for locating a particular commercial-off-the-shelf (COTS) item using a crowdsourcing engine, the system comprising:
a memory having a set of computer readable computer instructions, and
a processor for executing the set of computer readable instructions, the set of computer readable instructions including:
monitoring, with respect to a plurality of in-store users, for a set of in-store mobile user online searches which have both a set of in-store location data of the plurality of in-store users and a set of COTS item identifiers;
collecting, by the crowdsourcing engine in a database in response to detecting the set of in-store mobile user online searches, the set of in-store mobile user online searches which have both the set of in-store location data of the plurality of in-store users and the set of COTS item identifiers;
analyzing, by the crowdsourcing engine, the set of in-store mobile user online searches which have both the set of in-store location data of the plurality of in-store users and the set of COTS item identifiers;
receiving, from a new user, a request to locate a particular COTS item, wherein the set of COTS item identifiers indicates the particular COTS item;
computing, by the crowdsourcing engine based on the analyzing of the set of in-store location data of the plurality of in-store users and the set of COTS item identifiers which indicates the particular COTS item, an in-store location for the particular COTS item; and
providing, by the crowdsourcing engine to the new user in response to receiving the request to locate the particular COTS item, the in-store location for the particular COTS item.

19. A computer program product for locating a particular commercial-off-the-shelf (COTS) item using a crowdsourcing engine, the computer program product comprising a computer readable storage medium having program instructions embodied therewith, wherein the computer readable storage medium is not a transitory signal per se, the program instructions executable by a processor to cause the processor to perform a method comprising:
monitoring, with respect to a plurality of in-store users, for a set of in-store mobile user online searches which have both a set of in-store location data of the plurality of in-store users and a set of COTS item identifiers;
collecting, by the crowdsourcing engine in a database in response to detecting the set of in-store mobile user online searches, the set of in-store mobile user online searches which have both the set of in-store location data of the plurality of in-store users and the set of COTS item identifiers;
analyzing, by the crowdsourcing engine, the set of in-store mobile user online searches which have both the set of in-store location data of the plurality of in-store users and the set of COTS item identifiers;
receiving, from a new user, a request to locate a particular COTS item, wherein the set of COTS item identifiers indicates the particular COTS item;
computing, by the crowdsourcing engine based on the analyzing of the set of in-store location data of the plurality of in-store users and the set of COTS item identifiers which indicates the particular COTS item, an in-store location for the particular COTS item; and
providing, by the crowdsourcing engine to the new user in response to receiving the request to locate the particular COTS item, the in-store location for the particular COTS item.

20. The computer program product of claim 19, wherein at least one of:
the program instructions are stored in a computer readable storage medium in a data processing system, and wherein the program instructions were downloaded over a network from a remote data processing system; or
the program instructions are stored in a computer readable storage medium in a server data processing system, and wherein the program instructions are downloaded over a network to a remote data processing system for use in a computer readable storage medium with the remote data processing system.
